(19) United States
(12) Patent Application Publication
(10) Pub. No.: US 2010/0107867 A1
(43) Pub. Date: May 6, 2010

(54) LIFTER FOR LID OF MOTOR VEHICLE

(75) Inventor: Byoung Il Yoo, Gwangju (KR)

Correspondence Address: MORGAN, LEWIS & BOCKIUS LLP (SF), One Market, Spear Street Tower, Suite 2800, San Francisco, CA, 94105, US

(73) Assignee: HYUNDAI MOTOR COMPANY, Seoul (KR)

(21) Appl. No.: 12/464,698

(22) Filed: May 12, 2009

(30) Foreign Application Priority Data
Oct. 30, 2008 (KR) 10-2008-0107200

(51) Int. Cl. F15B 15/26

(52) U.S. Cl. 92/24

(57) ABSTRACT

A lifter for the lid of a motor vehicle may include a cylinder in which a fluid is filled, a first rod passing through one end of the cylinder so as to permit reciprocation therethrough, connected with a first piston slidably disposed in the cylinder and having at least an opening for a fluid communication through in the cylinder, and a second rod passing through a second, opposite end of the cylinder so as to permit reciprocation therethrough, connected with a second piston disposed in the cylinder and having at least an opening for a fluid communication in the cylinder so as to be opposite to the first piston, wherein the second rod has a cross section which is less than that of the first rod such that a magnitude of reaction force applied toward an outside of the cylinder is less than that of the first rod.

### CROSS-REFERENCE TO RELATED APPLICATIONS

The present application claims priority to Korean Patent Application Number 10-2008-0107200, filed on Oct. 30, 2008, the entire contents of which is incorporated herein for all purposes by this reference.

### BACKGROUND OF THE INVENTION

1. Field of the Invention

The present invention relates, in general, to a lifter for the lid of a motor vehicle, which is installed between a tail gate or a trunk lid and a body of the motor vehicle so as to enable a user to easily open or close the tail gate or the trunk lid.

2. Description of Related Art

Recently, a lifter has been installed between a trunk lid, a tailgate or a hood (bonnet) and a body so as to help a user open or close the trunk lid, tailgate or hood. Generally, such a lifter is filled up with gas, and thus is called a gas lifter. The trunk lid and tailgate are means of opening or closing a trunk, while the hood is means for opening or closing an engine compartment. The trunk lid, tailgate and hood are all configured with the same panel type as is the body, and thus the user has a great difficulty in opening or closing each and all of the trunk lid, the tailgate and the hood. The lifter is installed between each of these open-close means and the body so as to provide an opening force, and thus helps the user manipulate these open-close means without applying an excessive force.

The lifter is generally filled with a fluid consisting of either gas or liquid, thus expanding a cylinder rod using the force of the filled fluid so as to help manipulate the open-close means. The opening force is determined by pressure of the fluid filled in the cylinder, and is a function of the reaction force when the open-close means is closed. For this reason, it is necessary to very carefully determine the amount of the filled fluid.

However, the conventional lifter includes a cylinder and a rod sliding on one side of the cylinder. If the amount of filled fluid is increased in order to increase the opening force, an excessive closing force is required, which causes the user inconvenience. In detail, when the pressure of the fluid is increased, the force of the user required for closing increases. As such, when the pressure of the fluid is reduced for the convenience of the user, the pressure required to open the open-close means is insufficient. Thus, the opening force of the open-close means or a quality of operation when the open-close means is closed is a problem requiring selection of one of the alternatives from the viewpoint of the structure of the lifter.

The information disclosed in this Background of the Invention section is only for enhancement of understanding of the background of the invention, and should not be taken as an acknowledgement or any form of suggestion that this information forms the prior art that is already known to a person skilled in the art.

### BRIEF SUMMARY OF THE INVENTION

Various aspects of the present invention are directed to provide a lifter for the lid of a motor vehicle, which secures pressure required for opening, and does not require excessive pressure when in a closed state, thereby simultaneously satisfying an opening force and quality of the operation thereof when in the closed state.

In an aspect of the present invention, the lifter for the lid of a motor vehicle may include a cylinder in which a fluid is filled, a first rod passing through one end of the cylinder so as to permit reciprocation therethrough, connected with a first piston slidably disposed in the cylinder and having at least an opening for a fluid communication through in the cylinder, and a second rod passing through a second, opposite end of the cylinder so as to permit reciprocation therethrough, connected with a second piston disposed in the cylinder and having at least an opening for a fluid communication in the cylinder so as to be opposite to the first piston, wherein the second rod has a cross section which is less than that of the first rod such that a magnitude of reaction force applied toward an outside of the cylinder is less than that of the first rod., wherein the openings of the first and second pistons are orifice.

The first and second pistons may be identically shaped, and the cylinder includes first and second through-holes in opposite ends thereof which have cross sections identical to those of the first and second rods, and first and second sealing members on opposite sides thereof which enclose the respective rods inside the first and second through-holes so as to prevent leakage of the fluid.

The first and second sealing members may include a shock absorbing member on an inner surface of the first and second sealing members respectively so as to face the first and second pistons.

In another aspect of the present invention, the cylinder may have a length greater than a sum of lengths of the first and second rods.

In further another aspect of the present invention, the first and second rods may include first and second connectors on outer ends thereof which are connected to a body or a tail gate of the vehicle outside the cylinder in a ball-joint connecting fashion, respectively, wherein the second rod is contracted toward an inside of the cylinder when the tail gate is closed, and the first rod is contracted after the second rod is completely contracted, and wherein the first rod is first expanded toward the outside of the cylinder when the tail gate is open, and the second rod is expanded after the first rod has been completely expanded.

According to embodiments of the present invention, the lifter can maintain sufficient opening force and improve the quality of operation when closing using two simple rods sharing the fluid in the cylinder, wherein the two rods have different cross sections.

Further, although the fluid minutely leaks out toward an outside of the cylinder, the two rods share the fluid in one cylinder, and maintain a pressure difference thereof, so that the pressure difference between the rods can be maintained in the event of closing and opening.

In addition, a stroke of each rod is reduced by half as compared to a conventional lifter, so that durability of each rod sealing member is increased.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a cross-sectional view illustrating an exemplary lifter for the lid of a motor vehicle according to the present invention.

FIG. 2 is a cross-sectional view illustrating a first rod in the exemplary lifter for the lid of a motor vehicle illustrated in FIG. 1.

FIG. 3 is a cross-sectional view illustrating a second rod in the exemplary lifter for the lid of a motor vehicle illustrated in FIG. 1.

FIG. 4 illustrates the first operation of the exemplary lifter for the lid of a motor vehicle illustrated in FIG. 1.

FIG. 5 illustrates the second operation of the exemplary lifter for the lid of a motor vehicle illustrated in FIG. 1.

FIG. 6 illustrates the third operation of the exemplary lifter for the lid of a motor vehicle illustrated in FIG. 1.

FIG. 7 illustrates the fourth operation of the exemplary lifter for the lid of a motor vehicle illustrated in FIG. 1.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

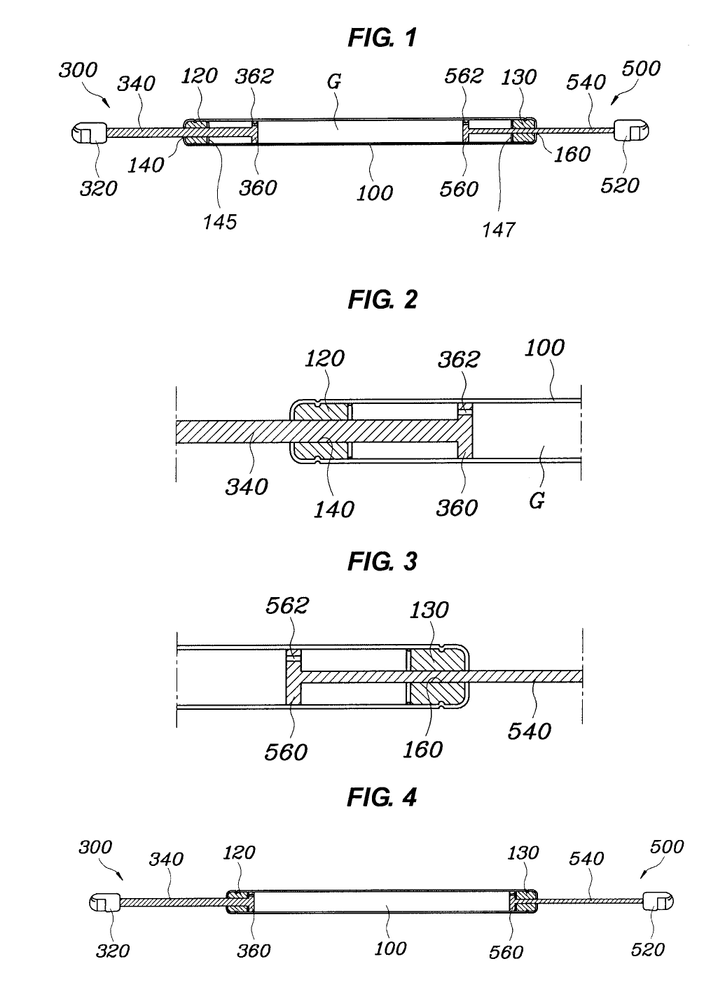

FIG. 1 is a cross-sectional view illustrating a lifter for the lid of a motor vehicle according to various embodiments of the present invention. According to various embodiments of the present invention, the lifter for the lid of a motor vehicle includes a cylinder 100 in which a fluid G is filled, a first rod 340 passing through one end of the cylinder 100 so as to permit reciprocation, connected with a first piston 360 having an orifice 362 for a flow of the fluid G in the cylinder 100, and having the shape of a bar, and a second rod 540 passing through the other end of the cylinder 100 so as to permit reciprocation, connected with a second piston 560 which has an orifice 562 for a flow of the fluid G in the cylinder 100 so that the flow is opposite to that of the first piston 360, and having the shape of a bar having a cross section less than that of the first rod 340 such that magnitude of reaction force applied toward the outside of the cylinder 100 is less than that of the first rod 340.

The cylinder 100 is a hollow cylinder having a predetermined length, and is provided with two rods 340 and 540 on opposite sides thereof which slide for contraction and expansion. As the fluid G in the cylinder 100, either of gas or liquid can be used for filling. The rods are coupled with connectors and pistons, thereby forming rod assemblies 300 and 500. Connection of each component will be described in detail. The first and second rod assemblies 300 and 500 are installed on the opposite sides of the cylinder 100, respectively. The rod assemblies include the first and second pistons 360 and 560 on inner ends thereof inside the cylinder 100, and the first and second connectors 320 and 520 on outer ends thereof outside the cylinder 100. The first and second connectors 320 and 520 are connected to an open-close means (e.g., a tail gate or a trunk lid) and a body of the motor vehicle in a ball-joint connecting fashion, respectively.

In various embodiments of the present invention, the first and second pistons 360 and 560 have a circular cross section so as to be in close contact with an inner circumference of the cylinder I 00, and are of a predetermined diameter. If the first and second pistons 360 and 560 are formed in the same shape, the costs of production are reduced. Thus, the first and second pistons 360 and 560 preferably have the same cross section and thickness. The first and second pistons 360 and 560 have outer diameters identical to an inner diameter of the cylinder 100. Oil is filled between the first and second pistons 360 and 560, thereby preventing the fluid G from leaking to the outside of the first and second pistons 360 and 560 and allowing the first and second pistons 360 and 560 to be smoothly slid.

The first and second pistons 360 and 560 have the respective orifices 362 and 562, through which the fluid G in the cylinder 100 flows to left and right sides of the pistons. Since the orifices 362 and 562 are formed in the first and second pistons 360 and 560, the fluid G has the same pressure on the left and right sides of each piston, so that the pressure of the fluid G itself is equally maintained regardless of position in the cylinder 100. Of course, when the pistons abruptly slide, the left-sided and right-sided pressures of the fluid may instantaneously differ from each other. This instantaneous pressure difference can be regulated by adjustment in the number and size of the orifices.

The first and second rods 340 and 540 are connected to the respective pistons in the cylinder 100 at first ends thereof and are exposed to the outside of the cylinder 100 at the second ends thereof, and are configured in such a manner that the cross sections thereof differ from each other. In various embodiments, the cross section of the second rod 540 is smaller than that of the first rod 340. The first and second rods 340 and 540 retract or protrude through first and second through-holes 140 and 160 formed in the opposite ends of the cylinder 100. The first and second through-holes 140 and 160 have different diameters depending on the cross sections of the rods. The cylinder 100 is provided therein with first and second sealing members 120 and 130 on the sides of the first and second through-holes 140 and 160 so as to block outward leakage of the fluid G. Further, through-holes of the first and second through-holes 140 and 160 through which the rods pass also have different diameters depending on the cross sections of the rods. The reason why a difference is made between the cross sections of the rods is for differentiating magnitudes of reaction forces applied to the rods, and a detailed principle thereof will be described below with reference to FIGS. 2 and 3.

In various embodiments of the present invention, shock absorbing members 145 and 147 may be installed in inner surface of the first and second sealing members 120 and 130 so as to absorb the impact that the first and second pistons 360 and 560 may act thereon.

FIG. 2 is a cross-sectional view illustrating a first rod, and FIG. 3 is a cross-sectional view illustrating a second rod. The first and second pistons 360 and 560 connected with the first and second rods 340 and 540 include the respective orifices 362 and 562, so that the pressures of the fluid G on the left and right sides of each piston in the cylinder 100 are identical to each other. The reaction force applied to the pistons and rods is always applied toward the outside of the cylinder 100, because the pressures applied to each piston on the opposite sides of each piston are different from each other. This pressure difference is generated by the cross section difference between the rods. In detail, a description will be made taking the first rod 340 of FIG. 2 by way of an example. The fluid is fully filled on the right side of the first piston 360, while the fluid is fully filled on the left side of the first piston 360 but is short of a volume of the first rod 340. Thus, since force caused by the applied pressure is derived from the product of a cross section and pressure per unit area, the force applied to the first piston 360 on the right side of the first piston 360 is greater than that applied to the first piston 360 on the left side of the first piston 360 because of the cross section of the first rod 340. This difference results in the reaction force by which the first rod 340 is pushed toward the outside of the cylinder. Of course, although pressure corresponding to external atmospheric pressure or weight of the open-close means will be applied to the cross section of the first rod 340, the pressure of the fluid G in the cylinder 100 is greater than this pressure, and thus the predetermined reaction force is applied to the first rod 340.

As described above, the reaction force applied to each rod is dependent on the cross section of each rod. In detail, as the cross section of each rod increases, the reaction force pushing the corresponding piston and rod in an outward direction increases. Comparing the first rod 340 of FIG. 2 with the second rod 540 of FIG. 3, the cross section of the first rod 340 is greater than that of the second rod 540, and thus the reaction force applied to the first rod 340 is greater than that applied to the second rod 540. The difference between these reaction forces makes it smooth to open and close the open-close means.

FIGS. 4 through 7 illustrate the process in which an open-close means is closed in an open state, and then is opened again. FIG. 4 illustrates the state in which an open-close means is open. When the open-close means is open, the first piston 360 reaches the first sealing member 120, so that the maximum expansion of the first rod 340 is achieved. The second piston 560 also reaches the second sealing member 130, so that the maximum expansion of the second rod 540 is achieved. In this state, the open-close means maintains the maximum opening angle. However, this configuration is merely one embodiment. In the practical realization, the maximum opening angle may be maintained in the state in which the second piston 560 does not reach the second sealing member 130.

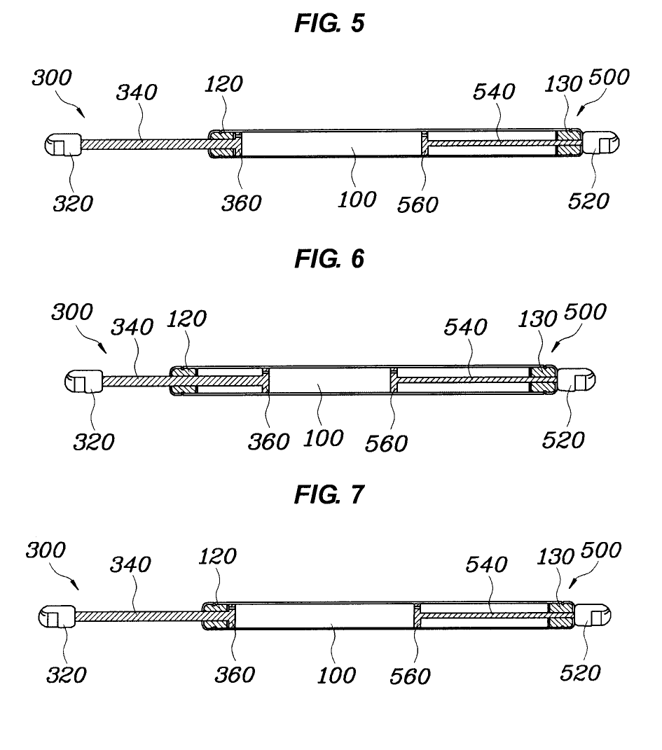

Meanwhile, when the user presses the open-close means in a downward direction in this state so as to transmit predetermined force, this force causes the second rod 540 having a weak reaction force to react first to be slidably contracted toward the inside of the cylinder 100 (see FIG. 5). The second rod 540 continues to be contracted until the second connector 520 reaches the end of the cylinder 100. After the contraction of the second rod 540 is completed, the first rod 340 begins to be contracted. In the state in which the first rod 340 is contracted to some extent, the open-close means maintains a completely closed state (see FIG. 6). In this state, when the user releases locking of the open-close means, the first rod 340 having a strong reaction force is expanded first (see FIG. 7). After the expansion of the first rod 340 is completed, the second rod 540 is expanded to enter the initial state of FIG. 4.

As described above, the difference between the reaction forces applied to the first and second rods 340 and 540 is always maintained in that state. The reaction force applied to the first rod 340 toward the outside of the cylinder 100 is adapted to be greater than that applied to the second rod 540 by making the cross section of the first rod 340 greater than that of the second rod 540. Thereby, the first rod 340 has an expanding force greater than that of the second rod 540. Further, the second rod 540 is contracted first when the open-close means is closed, and the first rod 340 is expanded first when the open-close means is open.

Thus, the open-close means begins to be closed by the contraction of the second rod 540 having a relative weak reaction force, while the open-close means begins to be opened by the expansion of the first rod 340 having a relative strong reaction force. As a result, when the open-close means is closed, the user can close the open-close means without applying strong force thereto. Further, the open-close means is opened by a relatively strong force. Unlike the conventional lifter, the opening force required when opening is increased, and simultaneously the reaction force generated when closing is decreased. Thus, quality of the operation which the user feels is improved. Further, the fluid G having the same pressure is shared in the cylinder 100, so that the difference between the reaction forces of the first and second rods 340 and 540 can be uniformly maintained although the fluid leaks out.

Since the two rods 340 and 540 are contracted or expanded on the opposite sides of the cylinder 100, a stroke of each rod is reduced by half as compared to the conventional lifter. Thus, the length of each rod exposed outside or entering inside is reduced, and thus a probability of damaging the sealing members 120 and 130 is remarkably reduced.

Meanwhile, in order to prevent the first and second pistons 360 and 560 from colliding with each other in the cylinder, the length of the cylinder 100 is designed to be greater than the sum of the lengths of the first and second rods 340 and 540.

In various embodiments of the present invention, the number and size of respective orifices 362 and 562 may be changed according to a variety of embodiments so that the damping coefficient of the first and second pistons 360 and 560 can be adjusted.

For convenience in explanation and accurate definition in the appended claims, the terms “outside”, “inner”, “upwards”, and “downwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A lifter for the lid of a motor vehicle comprising:
a fluid cylinder;
a first rod passing through one end of the cylinder so as to permit reciprocation therethrough, connected with a first piston slidably disposed in the cylinder and having at least an opening for a fluid communication therethrough; and
a second rod passing through a second, opposite end of the cylinder so as to permit reciprocation therethrough, connected with a second piston disposed in the cylinder and having at least an opening for a fluid communication therethrough so as to be opposite to the first piston,
wherein the second rod has a cross section which is less than that of the first rod such that a magnitude of reaction force applied toward an outside of the cylinder is less than that of the first rod.

2. The lifter as set forth in claim 1, wherein the openings of the first and second pistons are orifices.

3. The lifter as set forth in claim 1, wherein the first and second pistons are identically shaped, and the cylinder includes first and second through-holes in opposite ends thereof which have cross sections identical to those of the first and second rods, and first and second sealing members on opposite sides thereof which enclose the respective rods inside the first and second through-holes so as to prevent leakage of the fluid.

4. The lifter as set forth in claim 3, wherein the first and second sealing members include a shock absorbing member on a inner surface of the first and second sealing members respectively so as to face the first and second pistons.

5. The lifter as set forth in claim 1, wherein the cylinder has a length greater than a sum of lengths of the first and second rods.

6. The lifter as set forth in claim 1, wherein the first and second rods include first and second connectors on outer ends thereof which are connected to a body or a tail gate of the vehicle outside the cylinder in a ball-point connecting fashion, respectively.

7. The lifter as set forth in claim 6, wherein the second rod is contracted toward an inside of the cylinder when the tail gate is closed, and the first rod is contracted after the second rod is completely contracted.

8. The lifter as set forth in claim 6, wherein the first rod is first expanded toward the outside of the cylinder when the tail gate is open, and the second rod is expanded after the first rod has been completely expanded.

9. A passenger vehicle comprising the lifter as set forth in claim 1.
